(19) United States
(12) Patent Application Publication
(10) Pub. No.: US 2014/0265333 A1
(43) Pub. Date: Sep. 18, 2014

(54) Wood-gas power supply system with steady output voltage

(71) Applicant: Chung Shan Institute of Science and Technology, Armaments Bureau, M.N.D., (US)

(72) Inventors: Hsun-Ming Hsien, Taoyuan County (TW); Zhong-Yi Weng, Taoyuan County (TW); Yann-Long Kuo, Taoyuan County (TW); Chwen-Jiun Chen, Taoyuan County (TW); Kun-Feng Chen, Taoyuan County (TW)

(73) Assignee: Chung Shan Institute of Science and Technology, Armaments Bureau, M.N.D., Taoyuan County (TW)

(21) Appl. No.: 13/803,265

(22) Filed: Mar. 14, 2013

(51) Int. Cl. H02J 7/34

(52) U.S. Cl. CPC H02J 7/34
USPC 290/50

(57) ABSTRACT

An wood-gas power supply system include: a rectifier filter electrically coupled to a output power terminal of the wood-gas stove; a maximum power tracking circuit electrically coupled to the rectifier filter, providing a larger power; a feedback controller electrically coupled to the rectifier filter and the maximum power tracking circuit, allowing the power reach a request power value; and a DC/DC charging device receiving a current flowing the maximum power tracking circuit and converting the current to a direct current. The wood-gas power supply system applies energy storage elements and peripheral circuits to perform the closed loop control so as to adjust the output power for transmitting the steady output voltage, and to achieve the purpose of providing the steady power.

### BACKGROUND OF THE INVENTION

1. Field of the Invention

The present invention relates to a wood-gas power supply system with a steady output voltage, and more particularly, to a wood-gas power supply system, which applies energy storage elements and peripheral circuits to perform the closed loop control so as to adjust the output power for transmitting the steady output voltage.

2. Description of the Related Art

It is a development objective to search alternative energy resources to replace with petroleum for every country, such as solar, wind force, and tide, because of went short of petrochemical fuel increasingly. However, it is rich in the forest countries, and the waste woods spread all over anywhere. This phenomenon is ugly and wasteful.

The wood-gas power supply system is a device which burns the wood materials (dead woods, branches, rice straws, etc.) to generate power. FIG. 1 illustrates a structure schematic diagram of a conventional wood-gas power supply system. As shown in FIG. 1, the wood-gas power supply system cuts the wood material 11 to splinters 12 and transmits the splinters 12 to the smolder furnace 13 to perform the oxygen deficient combustion. The wood gas is generated from the splinters 12 during the oxygen deficient combustion process, and the wood gas is filtered by the filter device 14 for remaining the combustible gas. The combustible gas is transmitted to the engine device 15 to perform the burning so as to generate the power which drives the engine device 15. And the engine device 15 drives the electric generator 16 to generate the electric power. The power generated from the electric generator 16 is steady and the electrical standard reaches the single phase, AC 110Vrms and 60 Hz under the abundant combustible gas. Specifically, in order to allow the wood-gas stove output the steady power, it must control the feeding control valve and the combustible gas intake valve. Given that the wood material is continuously provided, if the feeding process is perform badly or the combustible gas intake valve is out of control, it will cause the engine device does not work properly and the voltage from the electric generator is not steady.

For the reason that the conventional method and device could not effectively solve the mentioned problems, a need has arisen to propose a wood-gas power supply system with a steady output voltage in order to overcome the aforementioned problems. The wood-gas power supply system with the steady output voltage provided by the present invention applies energy storage elements and peripheral circuits to perform the closed loop control so as to adjust the output power for transmitting the steady output voltage, and to achieve the purpose of providing the steady power of the wood-gas power supply system.

### SUMMARY OF THE INVENTION

An object of the present invention is to provide a wood-gas power supply system with a steady output voltage, which applies energy storage elements and peripheral circuits to perform the closed loop control so as to adjust the output power for transmitting the steady output voltage, and to achieve the purpose of providing the steady power of the wood-gas power supply system.

Another object of the present invention is to provide a wood-gas power supply system with a steady output voltage, configured to make a wood gas stove output provide a steady power, the wood-gas power supply system comprising: a rectifier filter electrically coupled to a output power terminal of the wood-gas stove, converting power from the wood-gas stove from AC to DC; a maximum power tracking circuit electrically coupled to the rectifier filter and providing a larger power; a feedback controller electrically coupled to the rectifier filter and the maximum power tracking circuit, comparing with the powers which flow the rectifier filter and the maximum power tracking circuit so as to provide a control signal to the maximum power tracking circuit to obtain a request power value; and a DC/DC charging device receiving a current flowing the maximum power tracking circuit, and converting the current to a direct current.

### BRIEF DESCRIPTION OF THE DRAWINGS

The invention, as well as its many advantages, may be further understood by the following detailed description and drawings in which:

FIG. 1 illustrates a structure schematic diagram of a conventional wood-gas power supply system.

FIG. 2 illustrates a structure schematically diagram of a wood-gas power supply system with steady output voltage of the present invention.

### DETAILED DESCRIPTION OF THE INVENTION

Referring to FIG. 2, which illustrates a structure schematically diagram of a wood-gas power supply system with steady output voltage of the present invention. As shown in FIG. 2, the wood-gas power supply system with steady output voltage comprises: a wood gas stove 20, a rectifier filter 21, a maximum power tracking circuit 22, a feedback controller 23 and a DC/DC charging device 24.

Specifically, the rectifier filter 21 is electrically coupled to a power output terminal of the wood gas stove 20, and the AC power generated by the wood gas stove 20 is converted to DC power by the rectifier filter 21. The DC power is transmitted to the maximum power tracking circuit 22. The rectifier filter 21 is a bridge rectifier, whenever the power generated from the wood gas stove 20 is lower, the maximum power tracking circuit 22 performs the electrical power storage, and it provides the power when the input power reaches the request power. Otherwise, when the power generated from the wood gas stove 20 is larger than request power, the maximum power tracking circuit 22 performs the discharge process so as to decrease the power passing by discharging slowly. The feedback controller 23 is electrically coupled between the output power terminals of the maximum power tracking circuit 22 and the rectifier filter 21. The power outputted from the rectifier filter 21 is compared by the feedback controller 23, and the power difference is traced by the maximum power tracking circuit 22 so as to generate a power adjustment signal to arrive the purpose of steady output current power.

The DC/DC charging device 24 is electrically coupled to the maximum power tracking circuit 22, and converts the power outputted from the maximum power tracking circuit 22 to the DC power, and then transmits the DC power to a storage device 25 (for example, a charged battery) to perform the charge process. Or the power in the storage device 25 is extracted by the inverter 26, and then converts the power to a steady AC power, and provides the steady AC power to the AC load 27, or incorporates the AC power to the utility power.

Many changes and modifications in the above described embodiment of the invention can, of course, be carried out without departing from the scope thereof. Accordingly, to promote the progress in science and the useful arts, the invention is disclosed and is intended to be limited only by the scope of the appended claims.

What is claimed is:

1. A wood-gas power supply system comprising:
A wood gas store;
a rectifier filter, electrically coupled to an output power terminal of the wood-gas stove, converting power of the wood-gas stove from AC to DC;
a maximum power tracking circuit, electrically coupled to the rectifier filter, providing a larger power;
a feedback controller, electrically coupled to the rectifier filter and the maximum power tracking circuit, comparing with power passing which flow the rectifier filter and the maximum power tracking circuit so as to provide a control signal to the maximum power tracking circuit to allow the power to reach a predetermined value; and
a DC/DC charging device, receiving a current flowing the maximum power tracking circuit, and converting the current to a direct current.

2. The wood-gas power supply system of claim 1, wherein the rectifier filter is a bridge rectifier.

3. The wood-gas power supply system of claim 1, wherein the maximum power tracking circuit (MPPT) is used for adjusting an input power.

4. The wood-gas power supply system of claim 1, wherein the DC/DC charging device receives the current flowing the maximum power tracking circuit, and coverts the current to the voltage from AC to DC, and then outputs the converted voltage to a storage device to perform a charge process.

5. The wood-gas power supply system of claim 4, wherein the storage device is a charged battery.

6. The wood-gas power supply system of claim 1, wherein power in the storage device is extracted by an inverter and the power is converted to a steady AC power, and the steady AC power is provided to a AC load.
